(19) United States
(12) Patent Application Publication
(10) Pub. No.: US 2025/0053609 A1
(43) Pub. Date: Feb. 13, 2025

(54) METHOD AND ELECTRONIC DEVICE FOR MATHEMATICALLY ESTIMATING CENTER OF POSITION TRAJECTORY OF OBJECT GENERATING SWING CAST-OFF SPATTER

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Ho Yong YIE, Wonju-si (KR); Young Il SEO, Wonju-si (KR); Jong Taek PARK, Wonju-si (KR); Kyu Young LIM, Wonju-si (KR)

(21) Appl. No.: 18/379,001

(22) Filed: Oct. 11, 2023

(30) Foreign Application Priority Data
Aug. 11, 2023 (KR) 10-2023-0105539

(51) Int. Cl. G06F 17/11

(52) U.S. Cl. CPC G06F 17/11

(57) ABSTRACT

A method of mathematically estimating the center of a position trajectory of an object generating a swing cast-off spatter includes obtaining position coordinates of a plurality of bloodstains to be analyzed, calculating collision angles of the plurality of bloodstains, generating straight lines based on the position coordinates and collision angles of the plurality of bloodstains, generating a triangle by selecting three of the generated straight lines, and generating an escribed circle of the triangle and calculating center coordinates and a radius length of the escribed circle.

### CROSS-REFERENCE TO RELATED APPLICATIONS

The present application is based on and claims priority to Korean Patent Application No. 10-2023-0105539 filed on Aug. 11, 2023, in the Korean Intellectual Property Office, which is incorporated herein by reference in its entirety.

### BACKGROUND

### 1. Field

One or more embodiments relate to a method and an electronic device for mathematically estimating the center of a position trajectory of an object generating a swing cast-off spatter.

### 2. Description of the Related Art

In criminal cases, bloodstain pattern analysis plays an important role in reconstructing the scene.

A swing cast-off spatter from among bloodstain forms is generated when blood escapes and collides with a floor under the influence of centrifugal force during a circular motion of the blood-stained object. The blood that escapes from the blood-stained object moves in a straight line in a tangential direction of a swinging circle, and may be affected by gravity and air resistance when a distance from the collided floor increases. The swing cast-off spatter is generated in a straight line because the swing cast-off spatter is generated due to a centrifugal force of the circular motion.

### SUMMARY

One or more embodiments include a method and an electronic device for improving the reliability of prediction of analysis results by estimating the center of a position trajectory of an object generating a swing cast-off spatter through mathematical analysis.

In addition, one or more embodiments include a method and an electronic device for reconstructing a crime scene and estimating a suspect by predicting a suspect's location, a suspect's tool, and a suspect's arm length.

According to one or more embodiments, a method of mathematically estimating the center of a position trajectory of an object generating a swing cast-off spatter includes obtaining position coordinates of a plurality of bloodstains to be analyzed, calculating collision angles of the plurality of bloodstains, generating straight lines based on the position coordinates and collision angles of the plurality of bloodstains, generating a triangle by selecting three of the generated straight lines, and generating a triangular escribed circle and calculating center coordinates and a radius length of the escribed circle.

In an embodiment, collision angles of the plurality of bloodstains may be calculated based on length and width of a bloodstain.

In an embodiment, the generating the straight lines may include generating the straight lines based on a straight-line equation below.

$$y = tan {α}^{′} * x + β$$

In the straight-line equation, α′=90-α, α is a collision angle of a bloodstain, and β is a y value of position coordinates of the bloodstain.

In an embodiment, the method may further include estimating a suspect's location, a suspect's arm length, and an object's length based on the center coordinates and radius length of the escribed circle.

A non-transitory computer-readable recording medium may have a program recorded thereon for executing a mathematical estimation method of the center of a position trajectory of an object generating a swing cast-off spatter.

According to one or more embodiments, an electronic device for mathematically estimating the center of a position trajectory of an object generating a swing cast-off spatter includes a processor configured to perform a program to mathematically estimate the center of a position trajectory of an object generating a swing cast-off spatter, and a memory configured to store the program, wherein the processor obtains position coordinates of a plurality of bloodstains to be analyzed, calculates collision angles of the plurality of bloodstains, generates straight lines based on the position coordinates and collision angles of the plurality of bloodstains, generates a triangle by selecting three of the generated straight lines, and generates a triangular escribed circle and calculates center coordinates and a radius length of the escribed circle.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a configuration diagram of an electronic device according to an embodiment;

FIG. 2 is a flowchart illustrating a method of mathematically estimating the center of a position trajectory of an object generating a swing cast-off spatter, according to an embodiment;

FIG. 3 is a view illustrating a collision between a blood drop and a floor;

FIG. 4 is a view of a straight line generated based on position coordinates and a collision angle of a bloodstain;

FIG. 5 is a view of three straight lines generated for three bloodstains;

FIG. 6 is a view of a triangle made of the straight lines of FIG. 5 and coordinates of its vertices;

FIG. 7 is a view of an escribed circle for the triangle of FIG. 6;

FIG. 8 is a view for explaining a calculation process of center coordinates of the escribed circle for the triangle of FIG. 6; and

FIG. 9 is a view illustrating side lengths of the triangle of FIG. 6.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various components, these components should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

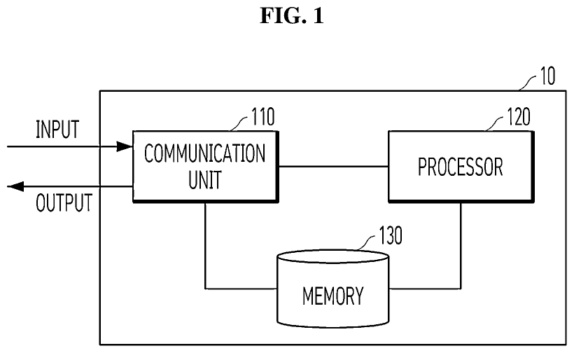

FIG. 1 is a configuration diagram of an electronic device 10 for mathematically estimating the center of a position trajectory of an object generating a swing cast-off spatter, according to an embodiment.

The electronic device 10 may include a communication unit 110, a processor 120, and a memory 130. The electronic device 10 to which the disclosure is applied may be an information processing device used by a user. However, the disclosure is not limited to thereto, and the electronic device 10 may further include other components or some components may be omitted.

For example, the electronic device 10 may be a personal computer (PC), a laptop computer, a mobile phone, a tablet PC, a smart phone, or a personal digital assistant (PDA).

The communication unit 110 is connected to the processor 120 and the memory 130 to transmit and receive data. The communication unit 110 may be connected to other external devices to transmit and receive data. Hereinafter, the expression “transmit and receive A” may refer to transmitting and receiving “information or data representing A.”

The communication unit 110 may be implemented as a circuitry within the electronic device 10. For example, the communication unit 110 may include an internal bus and an external bus. As another example, the communication unit 110 may be an element that connects the electronic device 10 to an external device. The communication unit 110 may be an interface. The communication unit 110 may receive data from the external device and transmit the data to the processor 120 and memory 130.

The processor 120 may control operations of the electronic device 10 according to an embodiment and perform logical operations.

The processor 120 processes data received by the communication unit 110 and data stored in the memory 130. The processor 120 may be a data processing device implemented in hardware that has a circuit with a physical structure for executing desired operations. For example, the desired operations may include code or instructions included in the program.

The processor 120 executes computer-readable code (e.g., software) stored in a memory (e.g., the memory 130) and instructions triggered by the processor 120.

For example, the processor 120 may obtain position coordinates of a plurality of bloodstains to be analyzed, calculate collision angles of the plurality of bloodstains, generate straight lines based on the position coordinates and collision angles of the plurality of bloodstains, generate a triangle by selecting three of the generated straight lines, and generate a triangular escribed circle and calculate center coordinates and a radius length of the escribed circle.

The memory 130 stores data received by the communication unit 110 and data processed by the processor 120. The memory 130 may store a program (or an application or software) that operates the electronic device 10. The stored program may be coded to control the electronic device 10 and may be executable by the processor 120.

The memory 130 may include a volatile memory such as static RAM (SRAM), dynamic RAM (DRAM) or synchronous DRAM (SDRAM), or a non-volatile memory such as a flash memory, phase-change RAM (PRAM), magnetic RAM (MRAM), resistive RAM (RRAM) or ferroelectric RAM (FRAM).

In addition, in other embodiments, the electronic device 10 may include more components than those in FIG. 1. For example, the electronic device 10 may further include other components such as a battery and charging device that supplies power to internal components, a database, etc.

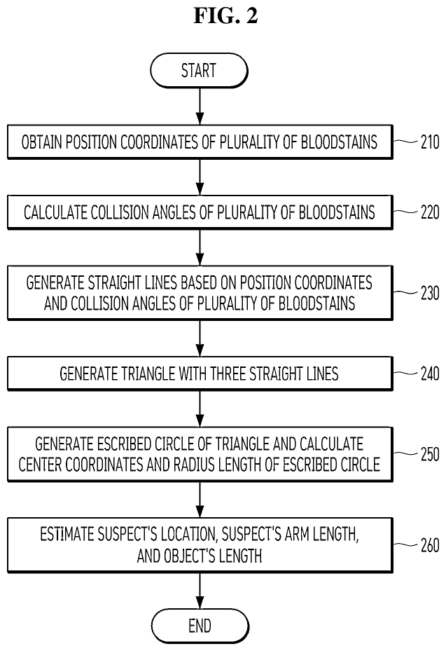

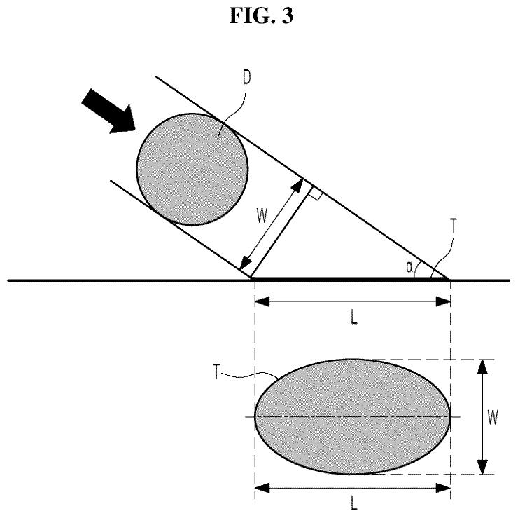

FIG. 2 is a flowchart illustrating a method of mathematically estimating the center of a position trajectory of an object generating a swing cast-off spatter, according to an embodiment. FIGS. 3 to 9 are views for explaining a method of mathematically estimating the center of a position trajectory of an object generating a swing cast-off spatter, according to an embodiment.

Hereinafter, with reference to FIGS. 2 to 9, a method of mathematically estimating the center of a position trajectory of an object generating a swing cast-off spatter according to an embodiment will be described.

The following operations 210 to 250 are performed by the electronic device 10 described above.

In operation 210, the electronic device 10 may obtain position coordinates of a plurality of bloodstains to be analyzed.

The plurality of bloodstains to be analyzed are swing cast-off spatters. A swing cast-off spatter is generated when blood escapes and collides with a floor under the influence of centrifugal force during a circular motion of the blood-stained object.

For example, the electronic device 10 may include a camera, and may obtain, by photographing a plurality of bloodstains through the camera, position coordinates of each bloodstain.

In operation 220, the electronic device 10 may calculate collision angles of the plurality of bloodstains.

FIG. 3 is a view illustrating a collision between a blood drop and a floor. Referring to FIG. 3, a collision angle between a blood drop D and a floor may be calculated by measuring length and width of a bloodstain T using Equation 1 below.

$$α = {sin}^{- 1} ( \frac{W}{L} ) \qquad [ Equation 1 ]$$

In Equation 1, α is a collision angle of a bloodstain, L is a length of the bloodstain, and W is a width of the bloodstain.

In operation 230, the electronic device 10 may generate straight lines based on the position coordinates and collision angles of the plurality of bloodstains.

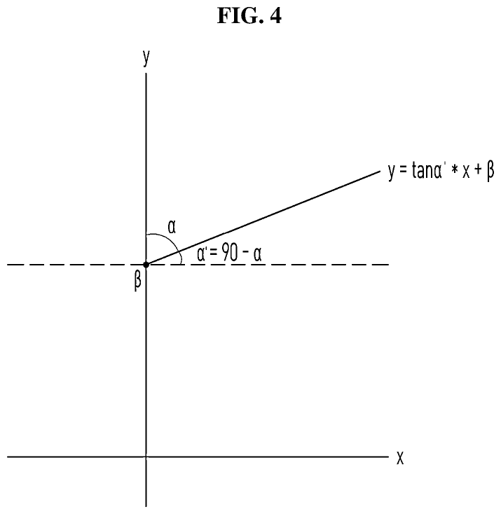

FIG. 4 is a view of a straight line generated based on position coordinates and a collision angle of a bloodstain. Referring to FIG. 4, an equation (Equation 2) of a straight line generated based on position coordinates and a collision angle of a bloodstain may be obtained.

$$y = tan {α}^{′} * x + β \qquad [ Equation 2 ]$$

In Equation 2, α′=90-α, a is the collision angle of the bloodstain, and β is a y value of the position coordinates of the bloodstain.

In operation 240, the electronic device 10 may generate a triangle by selecting three of generated straight lines.

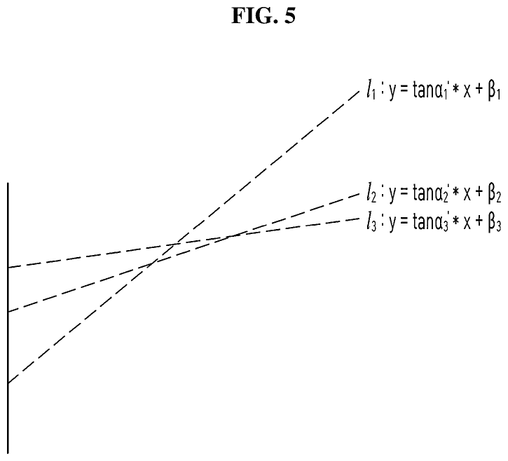

FIG. 5 is a view of three straight lines generated for three bloodstains. The three straight lines I₁, I₂, and I₃ may be expressed as Equation 3 below.

$${l}_{1} : y = tan {α}_{1}^{′} * x + {β}_{1} \\ {l}_{2} : y = tan {α}_{2}^{′} * x + {β}_{2} \\ {l}_{3} : y = tan {α}_{3}^{′} * x + {β}_{3} \qquad [ Equation 3 ]$$

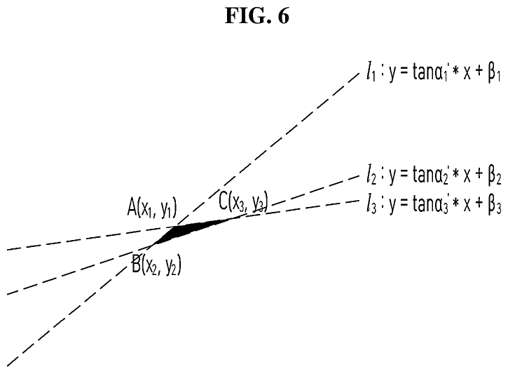

FIG. 6 is a view of a triangle made of the straight lines of FIG. 5 and coordinates of its vertices. Referring to FIG. 6, vertex coordinates of the triangle made of the straight lines of FIG. 5 may be expressed as A=(x₁,y₁), B=(x₂,y₂), and C=(x₃,y₃), respectively. Each value of the vertex coordinates may be expressed as in Equation 4 below.

$${x}_{1} = \frac{{β}_{3} - {β}_{1}}{tan {α}_{1}^{′} - tan {α}_{3}^{′}} , {y}_{1} = tan {α}_{1}^{′} * x + {β}_{1} \\ {x}_{2} = \frac{{β}_{2} - {β}_{1}}{tan {α}_{1}^{′} - tan {α}_{2}^{′}} , {y}_{2} = tan {α}_{2}^{′} * x + {β}_{2} \\ {x}_{3} = \frac{{β}_{3} - {β}_{2}}{tan {α}_{2}^{′} - tan {α}_{3}^{′}} , {y}_{3} = tan {α}_{3}^{′} * x + {β}_{3} \qquad [ Equation 4 ]$$

In operation 250, the electronic device 10 may generate a triangular escribed circle and calculate center coordinates and a radius length of the escribed circle.

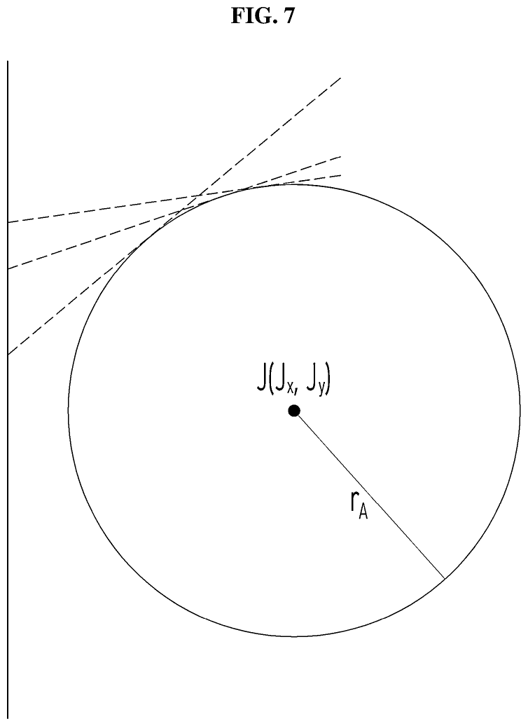

FIG. 7 is a view of an escribed circle for the triangle of FIG. 6.

The escribed circle is a circle that is tangent to one side of a given triangle and is tangent to extensions of the remaining two sides. The escribed circle is an intersection of a bisector of one interior angle and bisectors of the other two exterior angles in a generated triangle.

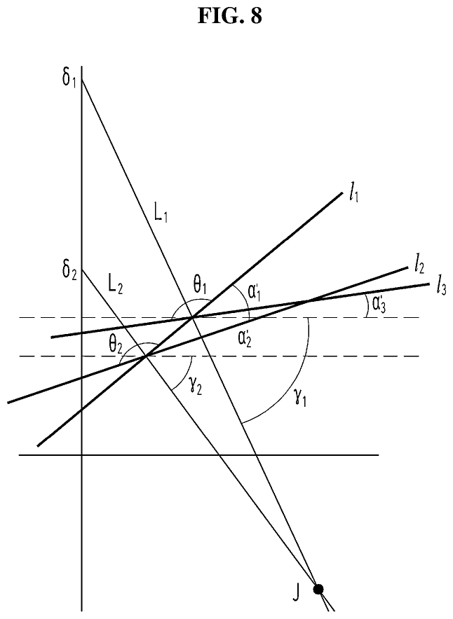

FIG. 8 is a view for explaining a calculation process of center coordinates of the escribed circle for the triangle of FIG. 6. Equation 5 below shows an equation for deriving center coordinates of the escribed circle for the triangle of FIG. 6.

$$\begin{matrix}{θ}_{1} = 180 - {α}_{1}^{′} + {α}_{3}^{′} , & {γ}_{1} = \frac{{θ}_{1}}{1} - {α}_{3}^{′} \\ {θ}_{2} = 180 - {α}_{1}^{′} + {α}_{2}^{′} , & {γ}_{2} = \frac{{θ}_{2}}{2} - {α}_{1}^{′} \\ {δ}_{1} = {y}_{1} + {x}_{1} * tan {γ}_{1} , & {δ}_{2} = {y}_{2} + {x}_{2} * tan {γ}_{2} \\ {L}_{1} : y = - tan {γ}_{1} * x + {δ}_{1} & \\ {L}_{2} : y = - tan {γ}_{2} * x + {δ}_{2} & \end{matrix} \qquad [ Equation 5 ]$$

Referring to FIG. 8, in Equation 5 above, θ₁ is an angle formed by the intersection of straight lines I₁ and I₃, and θ₂ is an angle formed by the intersection of straight lines I₁ and I₂. Straight lines L₁ and L₂ are straight lines that respectively bisect θ₁ and θ₂, and δ₁ and δ₂ are y-intercepts of the straight lines L₁ and L₂ that respectively bisect θ₁ and θ₂. γ₁ is an angle formed by the straight line L₁ with an x-axis, and γ₂ is an angle formed by the straight line L₂ with the x-axis.

To summarize Equation 5, center coordinates J (Jₓ,J_{y}) of the escribed circle facing vertex A is expressed as Equation 6 below.

$${J}_{x} = \frac{{δ}_{2} - {δ}_{1}}{tan {γ}_{1} - tan {γ}_{2}} \\ {J}_{y} = - tan {J}_{x} + {δ}_{1} \qquad [ Equation 6 ]$$

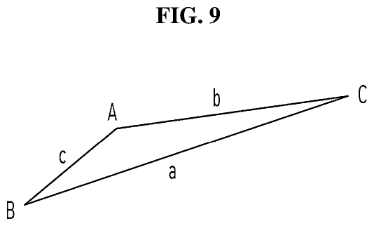

FIG. 9 is a view illustrating side lengths of the triangle of FIG. 6. Referring to FIG. 9, a radius length of the generated escribed circle may be calculated using a length of each side of the triangle and an area of the triangle in FIG. 6 as shown in Equation 7 below.

$${r}_{A} = \frac{S}{s - a} = \sqrt{\frac{s ( s - b ) ( s - c )}{s - a}} \qquad [ Equation 7 ]$$

In Equation 7 above, vertex coordinates of the triangle are A=(x₁,y₁), B=(x₂,y₂), and C=(x₃,y₃), respectively. a,b,c are respective lengths of sides of the triangle, S is an area of the triangle, s is a perimeter of the triangle (s=a+b+c), and r_{A} is a radius length of the escribed circle facing vertex A.

Equation 8 below shows a relationship between a length of each side of the triangle and the vertex coordinates.

$$a = \sqrt{{( {x}_{3} - {x}_{2} )}^{2} + {( {y}_{3} - {y}_{2} )}^{2}} \\ b = \sqrt{{( {x}_{1} - {x}_{2} )}^{2} + {( {y}_{1} - {y}_{2} )}^{2}} \\ c = \sqrt{{( {x}_{3} - {x}_{1} )}^{2} + {( {y}_{3} - {y}_{1} )}^{2}} \qquad [ Equation 8 ]$$

In Equation 8 above, the vertex coordinates of the triangle are A=(x₁,y₁), B=(x₂,y₂), and C=(x₃,y₃), respectively, a is a length of the side opposite vertex A of the triangle, b is a length of the side opposite vertex B of the triangle, c is a length of the side opposite vertex C of the triangle.

Equation 9 below summarizes final calculation results for the center coordinates J (Jₓ,J_{y}) and the radius length r_{A} of the escribed circle.

$${J}_{x} = \frac{{δ}_{2} - {δ}_{1}}{tan {γ}_{1} - tan {γ}_{2}} \\ {J}_{y} = - tan {J}_{x} + {δ}_{1} \\ {r}_{A} = \sqrt{\frac{s ( s - b ) ( s - c )}{s - a}} \qquad [ Equation 9 ]$$

The electronic device 10 may additionally perform operation 260. In operation 260, the electronic device 10 may estimate a suspect's location, a suspect's arm length, and an object's length based on the center coordinates and radius length of the escribed circle.

For example, the center coordinates of the escribed circle may correspond to the suspect's location, and the radius length of the escribed circle may correspond to a sum of the suspect's arm length and the object's length. Depending on an actual crime scene situation, factors to be considered in the above estimate may vary.

According to an embodiment, the reliability of prediction of analysis results may be improved by estimating the center of a position trajectory of an object generating a swing cast-off spatter through mathematical analysis.

In addition, according to an embodiment, a suspect's location, a suspect's tool, and a suspect's arm length may be predicted, contributing to reconstruction of a crime scene and estimation of a suspect.

A method according to embodiments may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier. The above hardware devices may be configured to operate as one or more software modules to perform the operations of the embodiments, and vice versa.

The software may include computer programs, code, instructions, or any combination thereof, and may construct a processing apparatus for desired operations or may instruct the processing apparatus independently or collectively. In order to be interpreted by the processing apparatus or to provide instructions or data to the processing apparatus, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and/or data may be recorded in one or more computer-readable recording media.

The description herein is for describing the disclosure and numerous modifications and adaptations will be readily apparent to one of ordinary skill in the art without departing from the spirit and scope of the disclosure. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

In this regard, the present embodiments may have different forms and should not be construed as being limited to the descriptions set forth herein. While the disclosure has been particularly shown and described with reference to embodiments thereof, it will be understood that various changes in form and details may be made therein without departing from the spirit and scope of the following claims.

What is claimed is:

1. A method of mathematically estimating a center of a position trajectory of an object generating a swing cast-off spatter, the method comprising:
obtaining position coordinates of a plurality of bloodstains to be analyzed;
calculating collision angles of the plurality of bloodstains;
generating straight lines based on the position coordinates and collision angles of the plurality of bloodstains;
generating a triangle by selecting three of the generated straight lines; and
generating an escribed circle of the triangle and calculating center coordinates and a radius length of the escribed circle.

2. The method of claim 1, wherein collision angles of the plurality of bloodstains are calculated based on length and width of a bloodstain.

3. The method of claim 1, wherein the generating the straight lines comprises:
generating the straight lines based on a straight-line equation below:
$$y = tan {α}^{′} * x + β$$
In the straight-line equation, α′=90-α, α is a collision angle of a bloodstain, and β is a y value of position coordinates of the bloodstain.

4. The method of claim 1, further comprising:
estimating a suspect's location, a suspect's arm length, and an object's length based on the center coordinates and radius length of the escribed circle.

5. A non-transitory computer-readable recording medium having recorded thereon a program for executing the method of claim 1.

6. An electronic device for mathematically estimating a center of a position trajectory of an object generating a swing cast-off spatter, the electronic device comprises:
a processor configured to perform a program to mathematically estimate a center of a position trajectory of an object generating a swing cast-off spatter; and
a memory configured to store the program,
wherein the processor obtains position coordinates of a plurality of bloodstains to be analyzed,
calculates collision angles of the plurality of bloodstains,
generates straight lines based on the position coordinates and collision angles of the plurality of bloodstains,
generates a triangle by selecting three of the generated straight lines, and
generates an escribed circle of the triangle and calculates center coordinates and a radius length of the escribed circle.
